(19) United States
(12) Patent Application Publication
(10) Pub. No.: US 2025/0335479 A1
(43) Pub. Date: Oct. 30, 2025

(54) DOMAIN SPECIFIC RETRIEVAL-AUGMENTED GENERATION FOR INDUSTRIAL APPLICATIONS

(71) Applicant: Aitomatic, Inc., Cupertino, CA (US)

(72) Inventors: Sang Xuan Dinh, Ho Chi Minh City (VN); The Vinh Luong, San Jose, CA (US); Zooey Nhu-Quynh Nguyen, Los Altos, CA (US); Christopher Nguyen, Los Altos, CA (US); Hong An Phan, San Jose, CA (US); Chanh Le Trung, Ho Chi Minh City (VN); Quynh Le Thi Tham, San Jose, CA (US); Anh Hai HA, Sunnyvale, CA (US); Timothy Michael Gerard Rozario, El Dorado Hills, CA (US); Phuoc Le Trong Bui, Ho Chi Minh City (VN); Hung Vo Phi, Ho Chi Minh City (VN); Phuong Thao Nguyen, Ho Chi Minh City (VN); Tan Loc Nguyen, Ho Chi Minh City (VN); Nanda Kishore, Los Altos, CA (US); Thai Luong Binh, Ho Chi Minh City (VN)

(21) Appl. No.: 19/190,589

(22) Filed: Apr. 26, 2025

Related U.S. Application Data
(60) Provisional application No. 63/640,155, filed on Apr. 29, 2024.

(51) Int. Cl. G06F 16/3329; G06F 16/334

(52) U.S. Cl. CPC G06F 16/33295; G06F 16/3347

(57) ABSTRACT

A system answers natural language questions using retrieval-augmented generation. The system stores a set of domain specific documents in a vector database. The system receives a natural language question. The system retrieves a subset of documents relevant to the natural language question from the vector database. The system determines prior knowledge information required in addition to the subset of documents retrieved from the vector database for answering the natural language question. The system generates a prompt for a machine learning based language model including instructions to the machine learning based language model to refrain from using prior knowledge obtained by the machine learning based language model during training of the machine learning based language model. The receives a response generated by executing the machine learning based language model based on the prompt. The system performs an action based on the response.

### CROSS REFERENCE TO RELATED APPLICATION

This application claims the benefit under 35 U.S.C. § 119(e) of U.S. Provisional Patent Application Ser. No. 63/640,155, filed Apr. 29, 2024, which is incorporated by reference in its entirety.

### FIELD OF INVENTION

The disclosure relates in general to artificial intelligence and machine learning techniques, and more specifically to domain specific retrieval-augmented generation based artificial intelligence techniques for industrial applications.

### BACKGROUND

Artificial intelligence (AI) techniques are useful for several industrial systems. For example, machine learning based language models are used for generating answers to various problems encountered in various settings. Examples of such machine learning based language models include Large Language Models (LLMs) such as GPT (generative pretrained transformer. These models are trained using a large corpus of text such as the internet, libraries of books and so on. As a result, such language models are trained to answer a generic set of questions. However, these language models lack domain specific knowledge required for answering questions relevant to domain specific problems, for example, questions relevant to specific industrial settings. Such questions require expert knowledge. Furthermore, these critical applications cannot tolerate hallucinations experienced by state-of-the-art language models. For example, large language models may manufacture facts and use them in answers. Such manufactured facts are not real and may not be usable for real world industrial settings. As a result, answers obtained from such language models are often inadequate.

### SUMMARY

A system answers natural language questions using retrieval-augmented generation. The system stores a set of documents in a vector database. According to an embodiment, the vector database stores domain specific documents for a particular domain, for example, an industrial domain from an industry such as a semiconductor industry, an oil and natural gas industry, or a manufacturing industry.

The vector database stores a vector representation of each document. The system receives a natural language question and generates a vector representation of the natural language question. The system retrieves a subset of documents relevant to the natural language question based on the vector representation of the natural language question. The system determines prior knowledge information required in addition to the subset of documents retrieved from the vector database for answering the natural language question. The system identifies a prior knowledge source system for accessing the prior knowledge information. The system accesses the prior knowledge source system to extract the prior knowledge information.

The system generates a prompt for a machine learning based language model, comprising (1) the natural language question, (2) the subset of documents retrieved from the vector database, (3) the prior knowledge information, and (4) instruction to the machine learning based language model to refrain from using prior knowledge obtained by the machine learning based language model during training of the machine learning based language model. The system provides the prompt to the machine learning based language model and receives a response generated by executing the machine learning based language model based on the prompt. The system performs an action based on the response.

Embodiments include computer-implemented methods that perform the steps for retrieval-augmented generation based answering of natural language questions described herein; non-transitory computer readable storage media storing instructions that when executed by one or more computer processors, cause the one or more computer processors to perform steps for retrieval-augmented generation based answering of natural language questions described herein; and computer systems comprising one or more computer processors, and a non-transitory computer readable storage medium storing instructions that when executed by the one or more computer processors, cause the one or more computer processors to perform steps for retrieval-augmented generation based answering of natural language questions described herein.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A illustrates the overall process executed by the system according to an embodiment.

FIG. 1B illustrates hierarchical decomposition of a task into subtasks, according to an embodiment.

FIG. 1C illustrates hierarchical task planning as performed by the system, according to an embodiment.

FIG. 1D illustrates the OODA process followed by the system, according to an embodiment.

FIG. 2 illustrates details of the process followed by the system to answer a query, according to an embodiment.

FIG. 3 illustrates an evaluation framework for determining whether the system is able to answer a query based on the currently available information, according to an embodiment.

FIG. 4 shows an example RAG based system based on LLM s that provides improved accuracy of results, according to an embodiment.

FIG. 5 is a flowchart illustrating the overall process for answering domain specific natural language questions using retrieval-augmented generation, according to an embodiment.

FIG. 6 is a high-level block diagram illustrating an example system, in accordance with an embodiment.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

The system according to an embodiment provides improved question-answering in industrial generative AI. The system integrates domain-specific model fine-tuning and iterative reasoning mechanisms into retrieval-augmented generation (RAG) workflows. The system achieves enhanced performance by utilizing a better retriever and generator, and by using multi-step reasoning. The system performs hierarchical task planning and breaks down complex tasks into sub-tasks and performs OODA-reasoning, a multi-step reasoning loop that is executed on a per-task basis. The system uses an OODA (observe, orient, decide and act) loop for iterative reasoning, leading to answers that approach human-expert quality by refining the process through observation, orientation, decision, and action phases.

### System Overview

The system comprises a framework designed to significantly enhance the performance of question-answering systems used in industrial settings. By incorporating domain-specific fine-tuning of both retrieval and generative models, along with an innovative application of iterative reasoning mechanisms, this system achieves a remarkable improvement in delivering precise and relevant answers. The system utilizes advanced embedding models that are fine-tuned to grasp the nuanced meanings of domain-specific terminologies, ensuring that the retrieval process is highly accurate and tailored to the specific needs of the industry.

Further elevating the system's capabilities is the use of a domain-adapted large language model (LLM) for answer generation. This model, enhanced through fine-tuning with domain-specific data, generates answers that are contextually relevant and also adhere to the desired presentation formats and logical structures unique to the domain. The system ensures that the answers generated meet the high standards expected in professional and industrial contexts, closely mimicking the depth of understanding and reasoning a human expert would provide.

The system performs hierarchical task planning by breaking down complex tasks into smaller subtasks and solving them. This can be a recursive process that further divides a subtask into smaller subtasks if necessary. The system according to an embodiment implements an OODA loop—observe, orient, decide, act—for iterative reasoning. This technique allows for continuous refinement of answers through successive iterations, enhancing the system's ability to process complex queries with a level of precision and relevance that approaches human expert quality. By systematically applying this loop, the system dynamically adjusts its strategies based on feedback, enabling a sophisticated understanding and handling of the intricacies involved in the questions it encounters. This iterative process not only optimizes the system's performance but also mirrors the adaptive and iterative nature of human problem-solving, making it suitable for solving problems in the field of industrial generative AI.

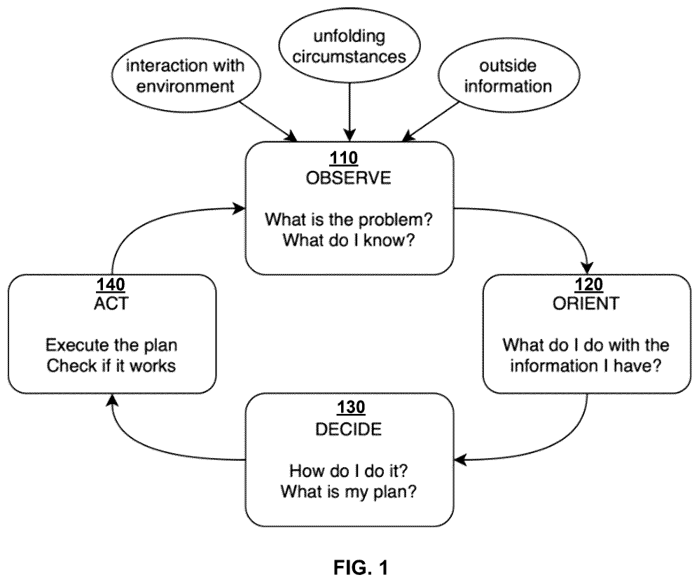

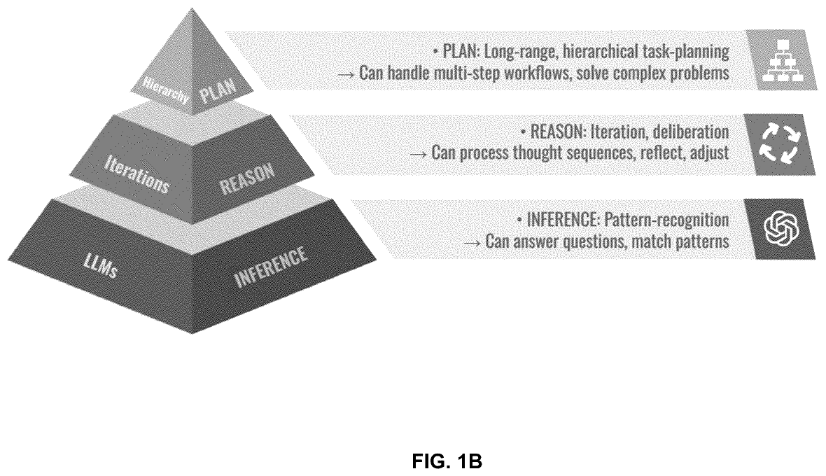

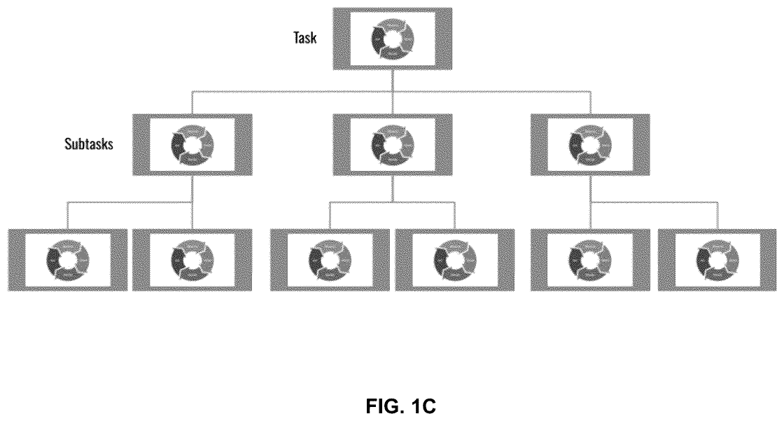

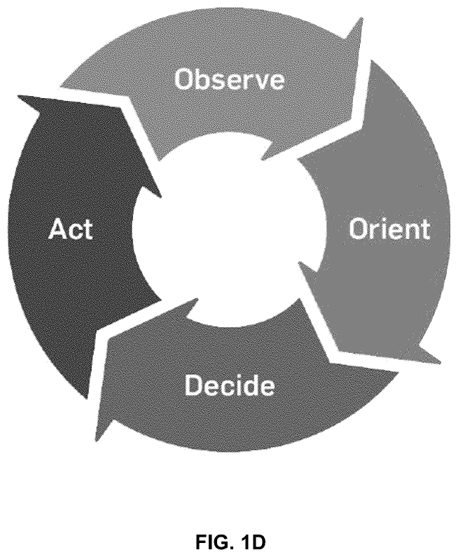

FIG. 1A illustrates the overall process executed by the system according to an embodiment. The system performs the following phases: observe phase 110, orient phase 120, a decide phase 130, and an act phase 140. In the observe phase 110 the system identifies the problem and determines the scope of the available knowledge. In the orient phase 120, the system determines what processing can be performed with the available information. In the decide phase 130 the system determines how to process the information and generates a plan. In the act phase 140 the system executes the plan and evaluates it to determine whether the plan worked. Accordingly, the system implements a reasoning framework based on the OODA loop.

FIG. 1B illustrates hierarchical decomposition of a task into subtasks, according to an embodiment. Accordingly, the system divides complex tasks into subtasks that are easier to execute, or the system divides a complex problem into smaller problems that are easier to answer.

FIG. 1C illustrates hierarchical task planning as performed by the system, according to an embodiment. The system performs hierarchical task planning and handles multi-step workflows and solves complex problems. The system reasons through complex problems and can process logical sequences. The system performs inferencing using pattern-recognition.

FIG. 1D illustrates the OODA process followed by the system, according to an embodiment. FIG. 1D illustrates the steps of observing, orienting, deciding, and acting as performed by the system.

According to an embodiment, the domain specific knowledge may be available as documents, for example, documents that are accessible within an organization. The system encodes the documents into embeddings and stores the embeddings of the documents in a vector database, for example, a structured index for processing in conjunction with the LLM. Examples of structured indexes include GPT-Index or LlamaIndex. The system receives a query and accesses relevant portions of the domain specific information from the vector database. The system adds the relevant portions of the domain specific information to a prompt that is generated for the LLM. This component acts as an A-Augmenter in RAG by adding to the relevant chunks retrieved as opposed to a traditional RAG.

The system performs the retrieval, augmentation, and generation and enhances each stage compared to the traditional approaches. For example, the system enhances the augmentation step by allowing experts to add new heuristics and domain specific rules that are incorporated in the system. Accordingly, the system adds domain expertise in the augmentation phase of a RAG framework. The system may observe a particular situation in an industrial setting, for example, the temperature of some equipment exceeds a threshold. There may not be any document in the vector database that includes the information to solve the current situation. However, an expert may have the knowledge to solve the situation, for example, by adjusting other parameters such as pressure of the equipment. The system allows experts to add rules to the knowledge of the system. Such rules provide very domain specific solutions to specific situations that may be encountered in an industrial setting.

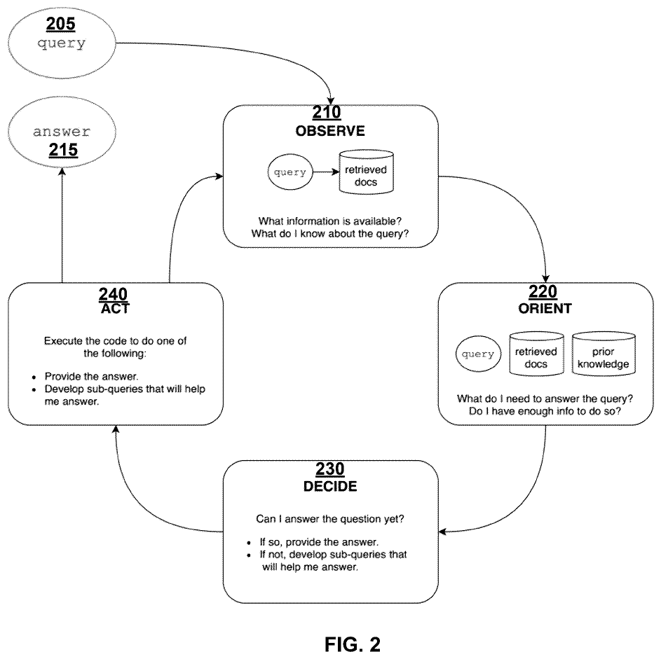

FIG. 2 illustrates details of the process followed by the system to answer a query, according to an embodiment. The system receives a query 205. The system performs the observe phase 210 in which the system searches through the available documents, for example, documents stored in a vector database to determine what the available information is relevant to the query 205. According to an embodiment, the system generates an embedding based on the query 205 and performs nearest neighbor search through the vector database using a similarity metric (e.g., cosine similarity) to identify relevant documents.

The system performs the orient phase 220 to determine what information is needed to answer the query 205. In this phase the system determines whether the available information to the system is able to answer the query 205. According to an embodiment, the system uses an evaluation framework based on multiple questions to determine whether the system is able to answer the question based on the currently available information.

The system performs the decide phase 230 to determine whether the system is able to answer the query 205 based on the available information. If the system determines that the query 205 can be answered based on the available knowledge, the system generates an answer 215. If the system determines that the available knowledge is not sufficient to answer the query 205, the system generates sub-queries that may help answer the query 205.

The system generates a plan for answering the question and performs the act phase 240. The system may execute code during the act phase 240. The code either provides the answer or develops sub-queries that will help generate the answer. The system stores any additional information, for example, code used to answer the query 205. The stored information may be used subsequently to answer additional queries. This way the system continues to build a domain specific knowledge base that increases over time. The loop shown in FIGS. 1 and 2 is executed iteratively and may be run multiple times.

The system may include a human in the loop for the orient phase 220 and/or the decide phase 230 to approve decisions. However, in other embodiments, the system may automatically perform the orient phase 220 and/or the decide phase 230.

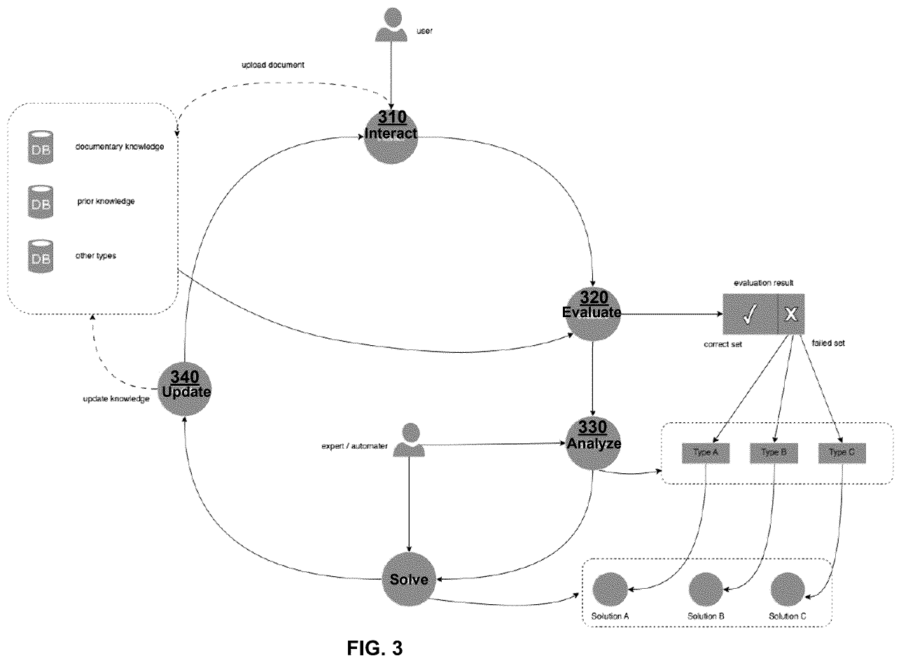

FIG. 3 illustrates an evaluation framework for determining whether the system is able to answer a query based on the currently available information, according to an embodiment. According to an embodiment, the system includes an evaluator module to evaluate the capabilities of the system. The system receives and stores a set of evaluation questions and answers for evaluating the system. This represents a ground truth that can be used to determine whether the system is able to answer these questions correctly. These questions are domain specific and test the knowledge or ability of the system (that represents an agent for answering domain specific queries). The system uses the current language model and knowledge base to answer the set of evaluation questions. The system compares the answers generated with the known answers in the ground truth data store to evaluate 320 the answer. The system may use the LLM to compare the generated answer with the ground truth answer stored in the system. For example, the system may generate a prompt including the generated answer and the ground truth answer and request the LLM to compare the two and provide a score indicating an accuracy of the generated answer. The system grades the knowledge of the system based on the accuracy of the answers generated for the evaluation questions. If the system determines based on the score that the answers are satisfactory, the system determines that the available knowledge of the system is sufficient to answer the query 205. If the generated answers are inadequate and not close to the ground truth answers, the system determines that the system needs additional information to be able to answer the query 205. According to an embodiment, the system compares the score obtained by the system by answering the evaluation questions with a threshold value. The system determines based on the result of the comparison whether the knowledge of the system is sufficient to answer the query 205.

For example, for an industry specific domain an evaluation question may ask the system to provide the type of material suitable for a particular task. The ground truth answer lists the material known to be suitable for the task. The system generates an answer using the LLM and the information stored in the vector database. The system compares the material identified by the system with the ground truth answers to determine whether the system identified at least some of the materials correctly, all of the materials correctly, or none of the materials correctly. The system scores the answer generates by the system for this question. The system grades all the questions and generates an aggregate score evaluating the capability of the system.

If the system determines that an answer was incorrect or inadequate, the system analyzes 330 the answer to determine why the answer was wrong. For example, the answer of a question may comprise a set of steps or a list of items. If the generated answer only includes a subset of steps of the subset of items and skips some key steps/items, the system scores the result low.

The system may generate a solution by generating code, for example, Python code. The system may use the LLM to generate the Python code. If the system determines that the cause of failure was lack of information the system may perform searches through various information stores for documents relevant to the query and store them in the vector database. The system repeats the full OODA loop again based on the updated knowledge. The system may improve its score due to increase in the knowledge of the system. If the score is still not sufficient, the system may iteratively continue repeating the steps until the score improves to a satisfactory value.

The evaluation question may test the knowledge of various processes. The evaluation question may test basic knowledge of material or equipment specific to the domain. The evaluation question may test knowledge of failures that may occur in the system. The evaluation question may check the ability of the system to determine existence of numerical errors, for example, correct values of the parameters.

According to an embodiment, the system determines following types of failures while evaluating the system: Process failures; Machine/maintenance failures; Numerical errors; Missing documentary knowledge; Missing experiential learning/knowledge. The system may present the category or categories decided as the cause of failure via a user interface to an expert. Alternatively, the system may automatically rank the available causes of failure and select the highest ranking cause.

The system is able to improve in a matter of days or hours and is able to update itself so that it is capable of answering questions correctly. The system furthermore is able to select a subset of knowledge or documents that are relevant to answering certain domain specific question. This prevents the system from unnecessarily storing a large amount of information that may not be needed. For example, organizations that prefer to keep their proprietary information confidential may share minimal information with the system so that the system is able to answer questions with minimal required information.

The system may be used to generate agents that have domain specific knowledge. Each agent has knowledge for a specific domain and does not have domain specific knowledge of other domains. This allows the system to create multiple domain specific agents that compartmentalize the knowledge rather than provide all the available knowledge of an organization in one agent. This allows the system to generate specialized agents having domain specific knowledge.

### EXAMPLE

Following are the details of the OODA reasoning loop implemented by the system. The system is able to answer complex domain specific queries. For example, the user query may be: “Does X Y Z phone company have a reasonably healthy liquidity profile based on its quick ratio for the fiscal year 2022, and if not, what other metric would be more relevant to measure its liquidity?”

The system implements following phases. Tasks are systematically broken down into subtasks across each phase.

### Observe Phase

The main task in the observe phase is to make observations relevant to the user query, for example, the system evaluates X Y Z phone company's liquidity using its quick ratio for FY 2022.

The system divides this task into subtasks that perform data extraction and preliminary calculation, for example, the system accesses and reviews X Y Z's FY 2022 financial statements to gather necessary data (current assets, inventories, current liabilities). The system may use a first calculation approach that applies the formula:

Quick Ratio=(Current Assets−Inventories)/Current Liabilities to compute a quick ratio of approximately 0.707.

The system may use a second calculation approach that computes a quick ratio focusing on cash and cash equivalents plus accounts receivable over current liabilities, resulting in approximately 0.54, adjusting for the absence of marketable securities data.

### Orient Phase

In the orient phase the main task performed by the system is to analyze the calculated quick ratios to understand their implications on X Y Z's liquidity. The system divides the main task into subtasks: (1) Comparison of Calculation Approaches: Reflect on how each calculation method influences the perception of X Y Z's liquidity. (2) Impact Assessment: Consider the significance of the quick ratios being less than 1 and its implications for X Y Z's ability to meet short-term obligations.

### Decide Phase

In the decide phase the main task the system performs is to make a determination about the healthiness of X Y Z's liquidity profile based on the quick ratio and its relevance as a metric. The system may divide the main task into subtasks: (1) Evaluation of Liquidity Concerns: Assess whether the quick ratios suggest a healthy liquidity profile for X Y Z. (2) Consideration of Other Factors: Decide whether the quick ratio alone can accurately reflect X Y Z's financial health or if other metrics and considerations are needed.

### Act Phase

In the act phase, the main task performed by the system is to conclude on X Y Z's liquidity profile and outline further considerations for a comprehensive analysis.

The system may divide the main task into subtasks: (1) Synthesis of Findings: Combine observations and analysis into a final assessment of X Y Z's liquidity. (2) Identification of Additional Analytical Needs: Highlight the need for further analysis, including comparison with industry benchmarks, exploration of other liquidity metrics (e.g., current ratio, operating cash flow), and consideration of X Y Z's long-term financial strategy.

This structured approach ensures a thorough and nuanced evaluation of X Y Z's liquidity profile, taking into account various aspects of financial health and strategic positioning within the industry.

The implementation process for this advanced question-answering system commences with environment setup and data preparation, involving detailed configurations and scripting to ensure seamless initial operations. The system's design incorporates a sophisticated evaluation mechanism, leveraging Python for data processing and analysis, enabling a deep understanding of performance metrics and areas necessitating refinement.

As the development transitions into the observer, orienter, decider, and actor phases, each stage employs targeted Python scripts and classes designed to meticulously evaluate performance, identify failures, and devise actionable solutions. This granular approach facilitates a nuanced understanding and addressing of system inadequacies, ensuring each component functions optimally within the broader architecture.

The incorporation of the iterative improvement loop, of the OODA methodology, fosters an environment of continuous evaluation and enhancement. This cycle of observation, orientation, decision-making, and action forms the backbone of the system's adaptive capabilities, allowing for iterative refinements that progressively elevate system performance to closely mirror human-expert level precision.

The system utilizes a structured approach from initial setup to final deployment, with an emphasis on rigorous testing, comprehensive documentation, and dedicated support. This ensures not only the system's robust functionality but also its adaptability and scalability, addressing the complex needs of industrial question-answering applications with precision and efficiency.

The system integrates domain-specific fine-tuning and iterative reasoning with Retrieval-Augmented Generation. The system uses the OODA loop for continuous refinement, making it highly adaptive and capable of producing human-expert level answers. The advantages include improved accuracy, relevance, and adaptability in complex industrial settings, offering a significant leap over traditional question-answering systems. Its application across various industries transform information retrieval and decision-making processes, making it a versatile and valuable tool.

Modified RAG Based System with Improved Accuracy

A system according to various embodiments, uses LLMs to answer natural language based questions from users, for example, natural language questions specific to a domain such as an industrial domain. The system is referred to as a RAG (retrieval-augmented generation) based system. The system provides a set of documents for use is answering the questions, for example, documents that represent domain knowledge. The documents may be stored in a document store, for example, a vector database and made available to the LLM. The document store may be referred to as domain knowledge store. The system uses LLM combined with the knowledge stored in the set of documents to answer domain specific questions. The accuracy of the answer obtained by the system using the LLM depends on the domain knowledge stored in the set of documents available in the document store as well as the prompt provided as input to the LLM. For example, the accuracy depends on the whether the prompt provided by the system to the LLM includes all the information needed to generate the answer to the natural language question received by the system. Conventional systems based on LLMs suffer from hallucinations since the LLM may manufacture an answer that appears coherent and grammatically correct but is factually incorrect or nonsensical and may include false or misleading information manufactured by the LLM. According to an embodiment, the system provides instructions to the LLM to not use any prior knowledge for answering the question and to only rely in the documents available in the document store (domain knowledge store) for answering the question. The system provides the additional knowledge (representing the prior knowledge that is not available in the document store) to the LL M in the prompt. For example, the natural language request may require knowledge of a formula or a process for computing a result based on information stored in the document store. The system may obtain the relevant formula from external sources, for example, using a search engine and provide the formula or the process for computing the result along with instructions to the LLM to not use any prior knowledge that the LLM has based on the training of the LLM for computing the result.

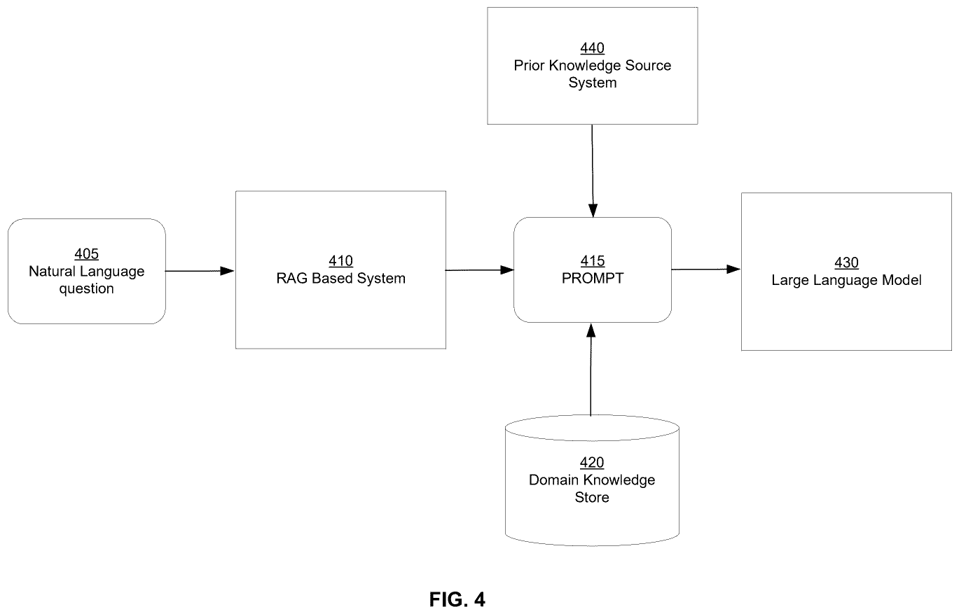

FIG. 4 shows an example RAG based system based on LLM s that provides improved accuracy of results, according to an embodiment. Other embodiments may include additional or fewer components than indicated in FIG. 4.

The RAG based system 410 may be an online system that receives natural language questions from users and answers the questions using a machine learning based language model, for example, large language model 430. The domain knowledge store 420 stores a set of documents representing particular knowledge, for example, a domain specific knowledge such as knowledge of particular industry. According to an embodiment, the domain knowledge store 420 is a vector database that stores embeddings of documents and uses embedding based search for documents that are within a vector distance of a natural language question. The RAG based system 410 receives a natural language question 405 for answering. The RAG based system 410 generates a vector representation of the natural language question 405. The RAG based system 410 access the domain knowledge store 420 to identify a subset of documents that are relevant to the natural language question 405, for example, a subset of documents that have vector representations that are closest to the vector representation of the natural language question.

The RAG based system 410 generates a prompt 415 for the large language model 430 based on the natural language question 405. The RAG based system 410 provides instructions in the prompt for the 430 instructing the large language model 430 to not use any prior knowledge that the large language model 430 may have acquired during training for answering the natural language question 405. The RAG based system 410 obtains any relevant prior knowledge that is not available in the domain knowledge store 420 from a prior knowledge source system 440. The RAG based system 410 includes the prior knowledge obtained from the prior knowledge source system 440 in the prompt 415. The RAG based system 410 provides the prompt 415 to the large language model 430 for processing.

The RAG based system 410 may further add the prior knowledge obtained from the prior knowledge source system 440 to the domain knowledge store 420 so that the prior knowledge does not have to be accessed from the prior knowledge source system 440 and is readily available in the domain knowledge store 420 for answering subsequent natural language questions 405. However, there may be other types of prior knowledge needed for answering subsequent natural language questions 405 that may still not be available in the domain knowledge store 420 and needs to be accessed from a prior knowledge source system 440 and included in the corresponding prompt 415 generated for the large language model 430 for answering the subsequent natural language questions 405.

Conventional systems retrain the large language model 430 using domain specific knowledge to improve the accuracy of the answers generated by the large language model 430. The accuracy may be measured using a set of questions that may test the knowledge of a domain. The accuracy may represent a percentage of questions of the set of questions that are correctly answered by the system. The system disclosed herein as shown in FIG. 4 provides a significantly higher level of accuracy compared to a conventional system based on retraining of the large language model 430 using the domain knowledge. For example, experimentally, a system using a retrained large language model 430 was observed to provide increase the accuracy approximately 10% on domain specific questions, the RAG based system 410 illustrated in FIG. 4 was observed to improve the accuracy by up to 30-40%. Accordingly, the RAG based system 410 illustrated in FIG. 4 provides much better accuracy when solving domain specific problems instead of a system that has high accuracy for a broad range of problems. Such a system is more valuable for handling domain specific problems such as industry specific problems that require high accuracy for domain specific problem and not high accuracy for a broad range of problems, for example, problems requiring general knowledge. The system disclosed in FIG. 4 may be considered overfitted for answering a generic set of questions, but it may be optimally fitted for a domain specific set of questions.

According to an embodiment, RAG based system 410 identifies the prior knowledge source system for accessing the prior knowledge information is based on the machine learning based language model.

According to an embodiment, RAG based system 410 generates another prompt requesting the machine learning based language model to identify a particular prior knowledge source system expected to include prior knowledge for solving the natural language question. The RAG based system 410 provides the other prompt to the machine learning based language model and receives a second response generated by executing the machine learning based language model based on the prompt. The RAG based system 410 identifies the prior knowledge source system 440 from the second prompt.

According to an embodiment, the machine learning based language model identifies one or more queries for accessing the prior knowledge source system to extract the prior knowledge information needed for answering the natural language question. For example, if the prior knowledge source system 440 is a database system, the RAG based system 410 may request the large language model 430 to generate a database query for accessing the for accessing the prior knowledge information from the database system. If the prior knowledge source system 440 is identified as a search engine, the RAG based system 410 may request the large language model 430 to generate one or more search queries for accessing the prior knowledge information from the search engine.

### Overall Process of Answering Domain Specific Natural Language Questions

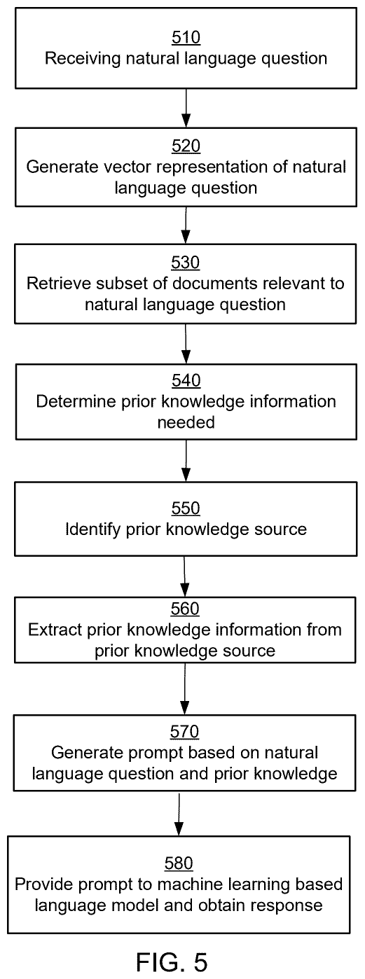

FIG. 5 is a flowchart illustrating the overall process for answering domain specific natural language questions using retrieval-augmented generation, according to an embodiment. The system stores a set of documents in a vector database that may store domain specific documents for a particular domain, for example, an industrial domain from an industry such as a semiconductor industry, an oil and natural gas industry, or a manufacturing industry. The vector database stores a vector representation of each document.

The system receives 510 a natural language question. The natural language question may be specific to a domain for which documents are stored in the vector database. The system generates 520 a vector representation of the natural language question. The vector representation may be generated by providing the natural language question as input to a machine learning based language model and represents an embedding of the natural language question.

The system retrieves 530 a subset of documents relevant to the natural language question based on the vector representation of the natural language question. For example, the subset of documents may represent documents determined to be closest to the natural language question based on a distance metric representing a vector distance between the vector representation of the natural language question and the vector representation of each of the subset of documents.

The system determines 540 prior knowledge information required in addition to the subset of documents retrieved from the vector database for answering the natural language question. The system identifies 550 a prior knowledge source system for accessing the prior knowledge information. The system accesses the prior knowledge source system to extract 560 the prior knowledge information.

The system generates 570 a prompt for a machine learning based language model, comprising (1) the natural language question, (2) the subset of documents retrieved from the vector database, (3) the prior knowledge information, and (4) instruction to the machine learning based language model to refrain from using prior knowledge obtained by the machine learning based language model during training of the machine learning based language model. The system provides 580 the prompt to the machine learning based language model and receives a response generated by executing the machine learning based language model based on the prompt.

The system performs an action based on the response. For example, the system may provide the answer to a user, for example, by sending the response to a client device for presentation to a user. Alternatively, the system may take an automatic action based on the response. For example, in an industrial setting the system may take an action that controls an industrial process, for example, by providing certain signal to a control, by shutting down a system, or by throttling a system.

According to an embodiment, the system identifies the prior knowledge source system for accessing the prior knowledge information is based on the machine learning based language model. Accordingly, the system generates a second prompt requesting the machine learning based language model to identify a particular prior knowledge source system expected to include prior knowledge for solving the natural language question and provides the second prompt to the machine learning based language model. The system receives a second response generated by executing the machine learning based language model based on the prompt and identifies the prior knowledge source system from the second prompt.

According to an embodiment, the system adds one or more documents comprising the prior knowledge information to the vector database.

### Applications

The system may be used in industries like semiconductor industry, oil and natural gas industry, or a manufacturing industry, where precision, efficiency, and decision-making speed are crucial. These sectors face complex challenges that require deep technical knowledge and rapid access to accurate information, making the system's domain-specific fine-tuning and iterative reasoning capabilities highly valuable. By offering improved accuracy and adaptability in information retrieval and analysis, the system enhances operational efficiencies, reduces costs, and drives better decision-making.

### Computer Architecture

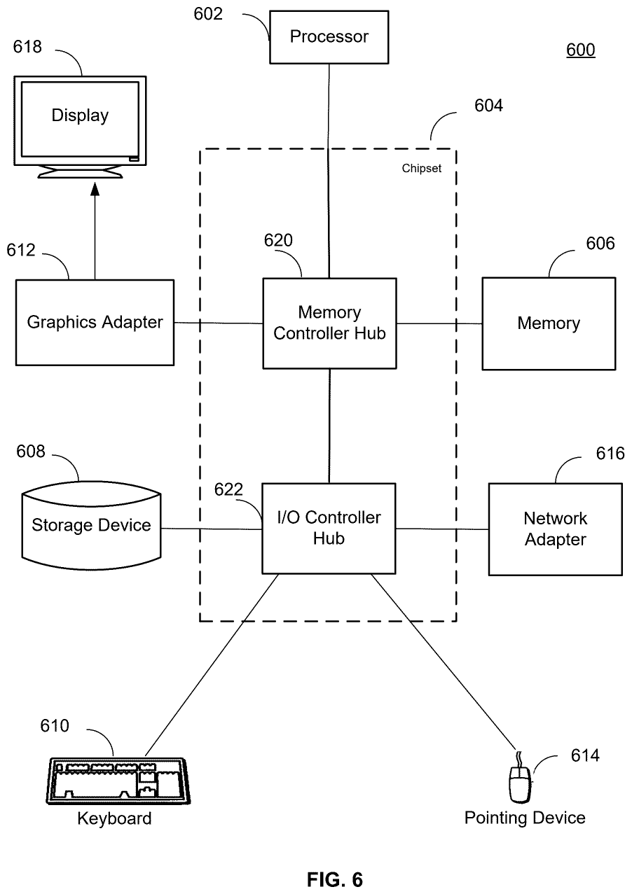

FIG. 6 is a high-level block diagram illustrating an example system, in accordance with an embodiment. The computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, or other type of pointing device, and is used in combination with the keyboard 610 to input data into the computer system 600. The graphics adapter 612 displays images and other information on the display 618. The network adapter 616 couples the computer system 600 to one or more computer networks.

The computer 600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 608, loaded into the memory 606, and executed by the processor 602. The types of computers 600 used can vary depending upon the embodiment and requirements. For example, a computer may lack displays, keyboards, and/or other devices shown in FIG. 6.

### ADDITIONAL CONSIDERATIONS

The disclosed embodiments increase the efficiency of storage of time series data and also the efficiency of computation of the time series data. The neural network helps convert arbitrary size sequences of data into fixed size feature vectors. In particular the input sequence data (or time series data) can be significantly larger than the feature vector representation generated by the hidden layer of neural network. For example, an input time series may comprise several thousand elements whereas the feature vector representation of the sequence data may comprise a few hundred elements. Accordingly, large sequences of data are converted into fixed size and significantly small feature vectors. This provides for efficient storage representation of the sequence data. The storage representation may be for secondary storage, for example, efficient storage on disk or for or used for in-memory processing. For example, for processing the sequence data, a system with a given memory can process a large number of feature vector representations of sequences (as compared to the raw sequence data). Since large number of sequences can be loaded at the same time in memory, the processing of the sequences is more efficient since data does not have to be written to secondary storage often.

Furthermore, the process of clustering sequences of data is significantly more efficient when performed based on the feature vector representation of the sequences as compared to processing of the sequence data itself. This is so because the number of elements in the sequence data can be significantly higher than the number of elements in the feature vector representation of a sequence. Accordingly, a comparison of raw data of two sequences requires significantly more computations than comparison of two feature vector representations. Furthermore, since each sequence can be of different size, comparison of data of two sequences would require additional processing to extract individual features.

Embodiments can performs processing of the neural network in parallel, for example using a parallel/distributed architecture. For example, computation of each node of the neural network can be performed in parallel followed by a step of communication of data between nodes. Parallel processing of the neural networks provides additional efficiency of computation of the overall process described herein, for example, in FIG. 4.

It is to be understood that the Figures and descriptions of the present invention have been simplified to illustrate elements that are relevant for a clear understanding of the present invention, while eliminating, for the purpose of clarity, many other elements found in a typical distributed system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for retrieval-augmented generation based answering of natural language questions, the computer-implemented method comprising:
storing a set of documents in a vector database, the vector database storing a vector representation of each of the set of documents;
receiving a natural language question;
generating a vector representation of the natural language question;
retrieving a subset of documents relevant to the natural language question based on the vector representation of the natural language question;
determining prior knowledge information required in addition to the subset of documents retrieved from the vector database for answering the natural language question;
identifying a prior knowledge source system for accessing the prior knowledge information;
accessing the prior knowledge source system to extract the prior knowledge information;
generating a prompt for a machine learning based language model, comprising:
the natural language question,
the subset of documents retrieved from the vector database,
the prior knowledge information, and
instruction to the machine learning based language model to refrain from using prior knowledge obtained by the machine learning based language model during training of the machine learning based language model;
providing the prompt to the machine learning based language model;
receiving a response generated by executing the machine learning based language model based on the prompt; and
performing an action based on the response.

2. The computer-implemented method of claim 1, wherein the vector database stores domain specific documents for a particular domain.

3. The computer-implemented method of claim 2, wherein the particular domain represents an industrial domain from one of:
a semiconductor industry,
an oil and natural gas industry, or
a manufacturing industry.

4. The computer-implemented method of claim 1, wherein the subset of documents represents documents from the set of documents that are determined to be closest to the natural language question based on a distance metric representing a vector distance between the vector representation of the natural language question and the vector representation of each of the subset of documents.

5. The computer-implemented method of claim 1, wherein identifying the prior knowledge source system for accessing the prior knowledge information is based on the machine learning based language model.

6. The computer-implemented method of claim 1, wherein the prompt is a first prompt, the response is a first response, wherein identifying the prior knowledge source system for accessing the prior knowledge information comprises:
generating a second prompt requesting the machine learning based language model to identify a particular prior knowledge source system expected to include prior knowledge for solving the natural language question;
providing the second prompt to the machine learning based language model;
receiving a second response generated by executing the machine learning based language model based on the prompt; and
identifying the prior knowledge source system from the second prompt.

7. The computer-implemented method of claim 1, further comprising:
adding one or more documents comprising the prior knowledge information to the vector database.

8. A non-transitory computer readable storage medium storing instructions that when executed by one or more computer processors, cause the one or more computer processors to perform steps for retrieval-augmented generation based answering of natural language questions, the steps comprising:
storing a set of documents in a vector database, the vector database storing a vector representation of each of the set of documents;
receiving a natural language question;
generating a vector representation of the natural language question;
retrieving a subset of documents relevant to the natural language question based on the vector representation of the natural language question;
determining prior knowledge information required in addition to the subset of documents retrieved from the vector database for answering the natural language question;
identifying a prior knowledge source system for accessing the prior knowledge information;
accessing the prior knowledge source system to extract the prior knowledge information;
generating a prompt for a machine learning based language model, comprising:
the natural language question,
the subset of documents retrieved from the vector database,
the prior knowledge information, and
instruction to the machine learning based language model to refrain from using prior knowledge obtained by the machine learning based language model during training of the machine learning based language model;
providing the prompt to the machine learning based language model;
receiving a response generated by executing the machine learning based language model based on the prompt; and
performing an action based on the response.

9. The non-transitory computer readable storage medium of claim 8, wherein the vector database stores domain specific documents for a particular domain.

10. The non-transitory computer readable storage medium of claim 9, wherein the particular domain represents an industrial domain from one of:
a semiconductor industry,
an oil and natural gas industry, or
a manufacturing industry.

11. The non-transitory computer readable storage medium of claim 8, wherein the subset of documents represents documents from the set of documents that are determined to be closest to the natural language question based on a distance metric representing a vector distance between the vector representation of the natural language question and the vector representation of each of the subset of documents.

12. The non-transitory computer readable storage medium of claim 8, wherein identifying the prior knowledge source system for accessing the prior knowledge information is based on the machine learning based language model.

13. The non-transitory computer readable storage medium of claim 8, wherein the prompt is a first prompt, the response is a first response, wherein identifying the prior knowledge source system for accessing the prior knowledge information comprises:
generating a second prompt requesting the machine learning based language model to identify a particular prior knowledge source system expected to include prior knowledge for solving the natural language question;
providing the second prompt to the machine learning based language model;
receiving a second response generated by executing the machine learning based language model based on the prompt; and
identifying the prior knowledge source system from the second prompt.

14. The non-transitory computer readable storage medium of claim 8, further comprising:
adding one or more documents comprising the prior knowledge information to the vector database.

15. A computer system comprising:
one or more computer processors; and
a non-transitory computer readable storage medium storing instructions that when executed by the one or more computer processors, cause the one or more computer processors to perform steps for retrieval-augmented generation based answering of natural language questions, the steps comprising:
storing a set of documents in a vector database, the vector database storing a vector representation of each of the set of documents;
receiving a natural language question;
generating a vector representation of the natural language question;
retrieving a subset of documents relevant to the natural language question based on the vector representation of the natural language question;
determining prior knowledge information required in addition to the subset of documents retrieved from the vector database for answering the natural language question;
identifying a prior knowledge source system for accessing the prior knowledge information;
accessing the prior knowledge source system to extract the prior knowledge information;
generating a prompt for a machine learning based language model, comprising:
the natural language question,
the subset of documents retrieved from the vector database,
the prior knowledge information, and
instruction to the machine learning based language model to refrain from using prior knowledge obtained by the machine learning based language model during training of the machine learning based language model;
providing the prompt to the machine learning based language model;
receiving a response generated by executing the machine learning based language model based on the prompt; and
performing an action based on the response.

16. The computer system of claim 15, wherein the vector database stores domain specific documents for a particular domain.

17. The computer system of claim 16, wherein the particular domain represents an industrial domain from one of:
a semiconductor industry,
an oil and natural gas industry, or
a manufacturing industry.

18. The computer system of claim 15, wherein the subset of documents represents documents from the set of documents that are determined to be closest to the natural language question based on a distance metric representing a vector distance between the vector representation of the natural language question and the vector representation of each of the subset of documents.

19. The computer system of claim 15, wherein identifying the prior knowledge source system for accessing the prior knowledge information is based on the machine learning based language model.

20. The computer system of claim 15, wherein the prompt is a first prompt, the response is a first response, wherein identifying the prior knowledge source system for accessing the prior knowledge information comprises:
generating a second prompt requesting the machine learning based language model to identify a particular prior knowledge source system expected to include prior knowledge for solving the natural language question;
providing the second prompt to the machine learning based language model;
receiving a second response generated by executing the machine learning based language model based on the prompt; and
identifying the prior knowledge source system from the second prompt.
